(19) United States
(12) Patent Application Publication
(10) Pub. No.: US 2014/0002469 A1
(43) Pub. Date: Jan. 2, 2014

(54) DRAWING DEVICE

(71) Applicant: Eisuke Yonezawa, Tokyo (JP)

(72) Inventor: Eisuke Yonezawa, Tokyo (JP)

(73) Assignee: Mitsubishi Electric Corporation, Chiyoda-ku, Tokyo (JP)

(21) Appl. No.: 14/005,391

(22) PCT Filed: Jun. 7, 2011
(86) PCT No.: PCT/JP2011/003201

§ 371 Date: Sep. 16, 2013

(51) Int. Cl. G06T 1/60

(52) U.S. Cl. CPC G06T 1/60
USPC 345/557

(57) ABSTRACT

A vector graphics data management unit 24 has a management table 25 holding pointers and priority ranks of caches to a cache unit 23. The management table 25 also holds a pointer whose priority rank is lower than those of pointers pointing to data cached by the cache unit 23. When receiving a drawing command, the vector graphics data management unit 24 carries out determination of whether a pointer included in the drawing command exists in the management table 25 and management of the management table 25 on the basis of a predetermined insertion rank when the pointer does not exist in the management table.

### FIELD OF THE INVENTION

The present invention relates to a drawing device that carries out information processing on vector graphics data expressed as a set of pieces of drawing information, such as vertex coordinates and color information of a graphic. More particularly, it relates to management of cache processing on data at a time of drawing vector graphics data on a display device.

### BACKGROUND OF THE INVENTION

A graphics drawing device typically carries out a process of, when a drawing command from a computing unit, such as a CPU, is issued, acquiring vector graphics data from an external storage unit, and carrying out a drawing process on the basis of this data and a process of displaying bit map data which is the result of the drawing process on a display device. For example, as shown in patent reference 1, by disposing a temporary storage unit for temporarily storing data from an external storage unit in a drawing device, the amount of data transfer between the external storage unit and the drawing device can be reduced and the drawing speed of the graphics drawing device can be improved.

Further, there is a case in which a cache for temporarily storing bit map data drawn is disposed between a drawing device and a display device, such as a monitor or a printer. Because the drawing process can be eliminated and the bit map data can be displayed on the display device by extracting the data from the data stored in this cache, the drawing speed is improved when the cost of the drawing process is high. In patent reference 2 and so on, the above-mentioned cache is called a font cache, and the target to be drawn is bit map data about characters having a high probability of being drawn repeatedly in many cases. As a method of deploying data into caches in this font cache, there are an LRU (Least Recently Used) method as described in patent reference 2, an FIFO method as described in patent reference 3, and a method for counting the frequency with which each of data is called and sorting these data according to the frequency, as described in patent references 4 and 5. The above-mentioned methods are aimed at improving the cache hit ratio, thereby improving the speed of the drawing process.

### RELATED ART DOCUMENT

### Patent Reference

Patent reference 1: Japanese Unexamined Patent Application Publication No. 08-077366
Patent reference 2: Japanese Unexamined Patent Application Publication No. 3-200196
Patent reference 3: Japanese Unexamined Patent Application Publication No. 3-48286
Patent reference 4: Japanese Unexamined Patent Application Publication No. 2-16068
Patent reference 5: Japanese Unexamined Patent Application Publication No. 11-301037

### SUMMARY OF THE INVENTION

### Problems to be Solved by the Invention

A problem is, however, that the method of selecting a cache only optimizes the access method of accessing the memory for the temporary storage unit disposed in the above-mentioned drawing device, and the temporary storage unit does not have an optimal cache structure for data that are called repeatedly. Another problem is that while a suggestion about the above-mentioned method of selecting a cache is offered for the font cache, the cache hit ratio is low when using any of the LRU method and the FIFO method as described respectively in patent reference 2 and patent reference 3. A further problem is that the circuit scale becomes large easily in the case of using the method for counting the frequency with which each of data is called and sorting these data according to the frequency, as described in patent references 4 and 5.

The present invention is made in order to solve the problems, and it is therefore an object of the present invention to provide a drawing device that can prevent the circuit scale thereof from being enlarged and improve the drawing speed.

### Means for Solving the Problem

In accordance with the present invention, there is provided a drawing device that generates image data to be displayed on a display device by using vector graphics data stored in an external storage unit, the drawing device including: a drawing unit responsive to a drawing command which includes a pointer pointing to vector graphics data stored in the external storage unit and which is outputted from an arithmetic device, for generating bit map data from the vector graphics data pointed to by the pointer; a cache unit for caching vector graphics data stored in the external storage unit; and a vector graphics data management unit having a management table for holding the pointer and a priority rank of a cache to the cache unit, for managing cached data in the cache unit on the basis of the management table and for carrying out transfer control of vector graphics data used by the drawing unit, in which the cache unit caches vector graphics data pointed to by a pointer whose priority rank held by the management table is high, and the vector graphics data management unit also manages a pointer whose priority rank is lower than that of the pointer pointing to the vector graphics data cached by the cache unit in the management table.

### Advantages of the Invention

The drawing device in accordance with the present invention has the management table for holding the pointer and the priority rank of the cache to the cache unit, and also manages a pointer whose priority rank is lower than that of the pointer pointing to the vector graphics data cached by the cache unit. As a result, the drawing device can prevent the circuit scale thereof from being enlarged and improve the drawing speed.

### BRIEF DESCRIPTION OF THE FIGURES

FIG. 1 is a block diagram showing a drawing device in accordance with Embodiment 1 of the present invention;

FIG. 2 is an explanatory drawing showing an example of the contents of a management table in the drawing device in accordance with Embodiment 1 of the present invention;

FIG. 3 is a flowchart showing the operation of a vector graphics data management unit in the drawing device in accordance with Embodiment 1 of the present invention;

FIG. 4 is an explanatory drawing showing an example of inserting data which is not included in the management table in the drawing device in accordance with Embodiment 1 of the present invention;

FIG. 5 is an explanatory drawing showing an example of an operation in a case in which invalid pointer data is included at a higher rank than an insertion level in the management table in the drawing device in accordance with Embodiment 1 of the present invention;

FIG. 6 is an explanatory drawing showing an example of an operation in a case in which invalid pointer data is included at a lower rank than an insertion level in the management table in the drawing device in accordance with Embodiment 1 of the present invention;

FIG. 7 is an explanatory drawing showing an example of an operation when a drawing command for drawing vector graphics data pointed to by a pointer whose rank is higher than an insertion rank in the management table in the drawing device in accordance with Embodiment 1 of the present invention is issued;

FIG. 8 is an explanatory drawing showing an example of an operation when a drawing command for drawing vector graphics data pointed to by a pointer whose rank is lower than an insertion rank in the management table in the drawing device in accordance with Embodiment 1 of the present invention is issued;

FIG. 9 is an explanatory drawing showing an example of an operation when a drawing command for drawing vector graphics data pointed to by a pointer whose rank is lower than an insertion rank in the management table in the drawing device in accordance with Embodiment 1 of the present invention is issued; and

FIG. 10 is an explanatory drawing showing an example of an operation when a cache exchange inhibit flag is introduced into a management table in a drawing device in accordance with Embodiment 2 of the present invention.

### EMBODIMENTS OF THE INVENTION

Hereafter, in order to explain this invention in greater detail, the preferred embodiments of the present invention will be described with reference to the accompanying drawings.

### Embodiment 1

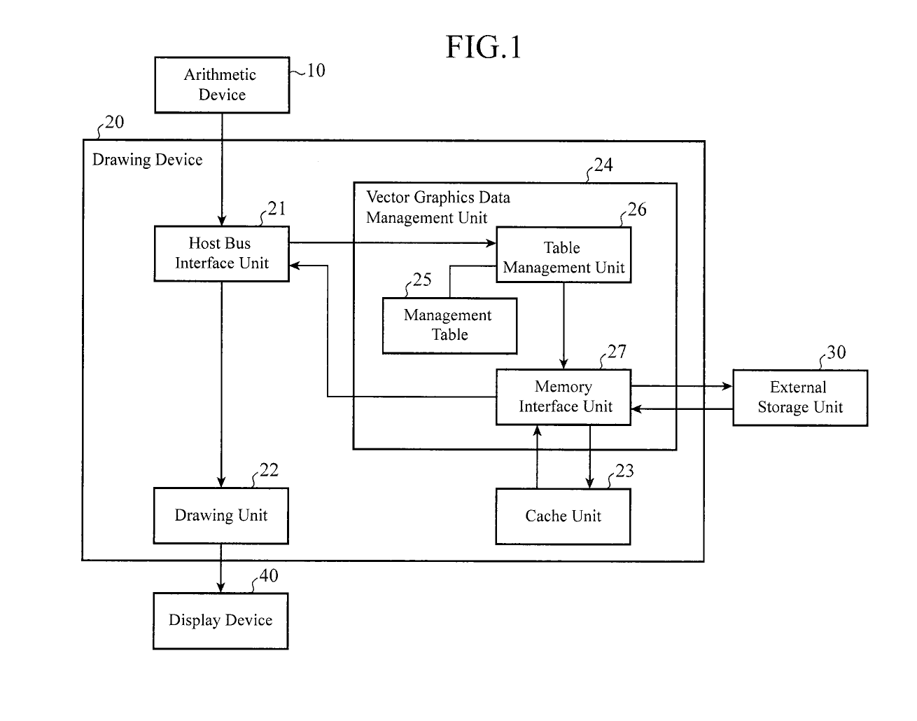

FIG. 1 is a block diagram showing a drawing device in accordance with this embodiment. The drawing device 20 in accordance with this embodiment displays an image on a display device 40 by using vector graphics data stored in an external storage unit 30 according to a drawing command from an arithmetic device 10, and is provided with a host bus interface unit 21, a drawing unit 22, a cache unit 23, and a vector graphics data management unit 24. Further, the drawing device 20 can be constructed of a computer.

The arithmetic device 10 can consist of a CPU or the like that issues a drawing command including a pointer pointing to vector graphics data stored in the external storage unit 30, and the external storage unit 30 can be a DRAM or a hard disk drive unit for storing vector graphics data therein. The display device 40 can be a liquid crystal display monitor, a projector, a printer, or the like for producing an information display.

The host bus interface unit 21 in the drawing device 20 is a block for interpreting a drawing command from the arithmetic device 10, the drawing unit 22 is a block for interpreting vector graphics data and performing drawing, the cache unit 23 is a storage unit disposed in the drawing device, for temporarily storing data from the external storage unit 30 and making it possible for the data to be reused, and the vector graphics data management unit 24 is a block for managing an exchange of data between the drawing device and the external storage unit 30 or the cache unit 23.

Pinter information about a pointer pointing to vector graphics data stored in the external storage unit 30 is included in a drawing command from the arithmetic device 10, and the host bus interface unit 21 issues a request to acquire data to the vector graphics data management unit 24 according to the pointer information. When the data exists in the cache unit 23, the vector graphics data management unit 24 reads the data from the cache unit 23. In contrast, when the data does not exist in the cache unit, the vector graphics data management unit reads the data from the external storage unit 30 and transfers the data to the host bus interface unit 21. When receiving the vector graphics data from the vector graphics data management unit 24, the host bus interface unit 21 transfers the data to the drawing unit 22, and the drawing unit 22 performs a drawing process based on the data and causes the display device 40 to display a bitmapped image thereon.

The vector graphics data management unit 24 has a management table 25, a table management unit 26, and a memory interface unit 27. The management table 25 is a table used for carrying out cache management of vector graphics data, and the table management unit 26 is a block for referring to and managing this management table 25. The memory interface unit 27 is a block for acquiring data from the cache unit 23 and the external storage unit 30 according to a request from the table management unit 26, and transferring the data to the host bus interface unit 21.

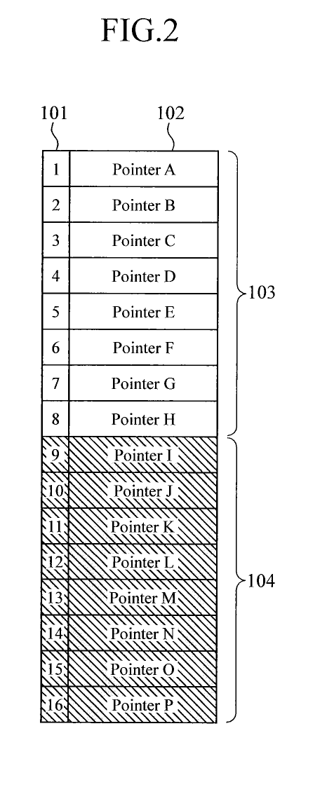

FIG. 2 shows an example of data stored in the management table 25. The management table 25 stores both ranks 101 each showing a priority rank of a cache to the cache unit 23 and pointer data 102 each showing a pointer pointing to graphic object data stored in the external storage unit 30. In this example, graphic object data pointed to by pointer data 103 corresponding to eight top ranks 101 in the management table 25 are recorded in the cache unit 23. While vector graphics data pointed to by pointer data 104 whose ranks 101 range from 9 to 16 are not stored in the cache unit 23, these pointer data and corresponding priority ranks are managed in the management table 25. In this example, the 16 data pointers in total are managed while eight of the pointers point to vector graphics data stored in the cache unit 23 and the eight remaining pointers are managed only on the management table 25. It is needless to say that these numbers can vary from one system to another.

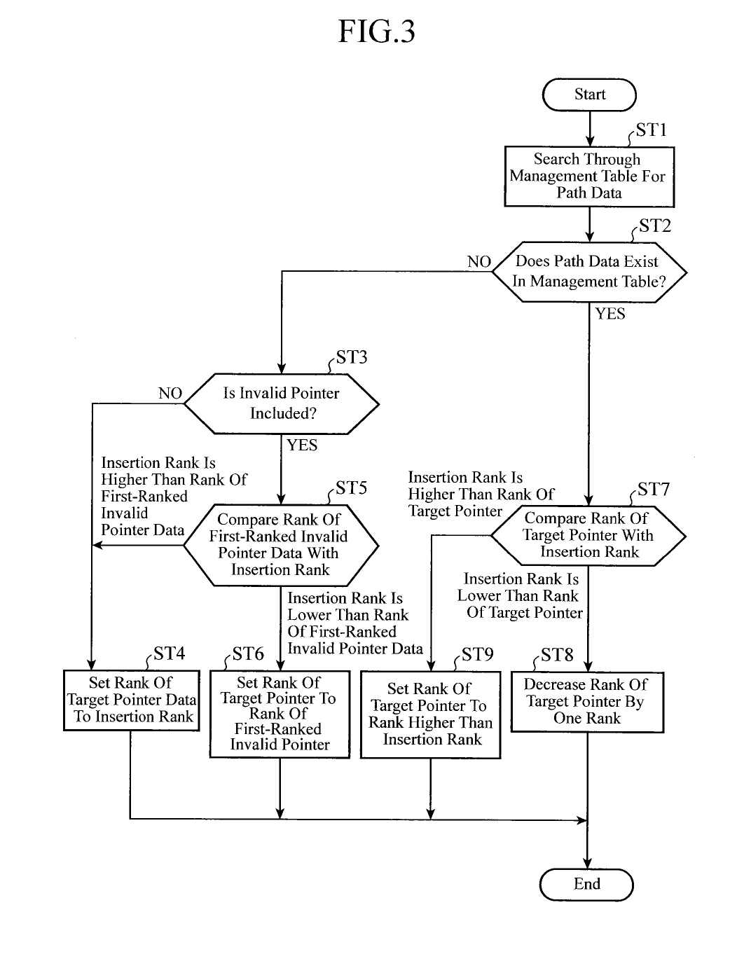

FIG. 3 shows a table management algorithm of the table management unit 26. When receiving a drawing command from the host bus interface unit 21, the table management unit searches through the management table 25 to determine whether or not the pointer data pointing to the target graphics object data is included in the management table 25 (step ST1). When determining that the target pointer data is not included in the management table 25 as the result of the search (step ST2), the table management unit checks whether or not invalid pointer data is included in the management table 25 (step ST3). Invalid pointer data is pointer data in a state which no data pointed to by the pointer data is stored in the cache unit 23, and the pointer data is not a target for management in the management table 25. For example, all the pointers stored in the management table 25 in an initial state are invalid ones.

When, in step ST3, determining that no invalid pointer data is included in the management table, the table management unit sets the rank of the target pointer data to an insertion rank set to the management table 25 (step ST4). When determining that invalid pointer data is included in the management table, the table management unit compares the rank of the first-ranked invalid pointer data with the insertion rank (step ST5). When the insertion rank is higher than the rank of the first-ranked invalid pointer data, the table management unit shifts to step ST4, like in the case in which no invalid pointer is included in the management table (when NO in step ST3), the table management unit sets the rank of the target pointer to the insertion rank. In contrast, when, in step ST5, the insertion rank is lower than the rank of the first-ranked invalid pointer data, the table management unit sets the rank of the target pointer to the rank of the first-ranked invalid pointer (step ST6). In contrast, when, in step ST2, determining that the target pointer data is included in the management table 25, the table management unit compares the rank of the target pointer with the insertion rank (step ST7). When determining that the insertion rank is lower than the rank of the target pointer as the result of the comparison, the table management unit increases the rank of the target pointer by one rank (step ST8). In contrast, when determining that the insertion rank is higher than the rank of the target pointer, the table management unit sets the rank of the target pointer to a rank higher than the insertion rank (step ST9).

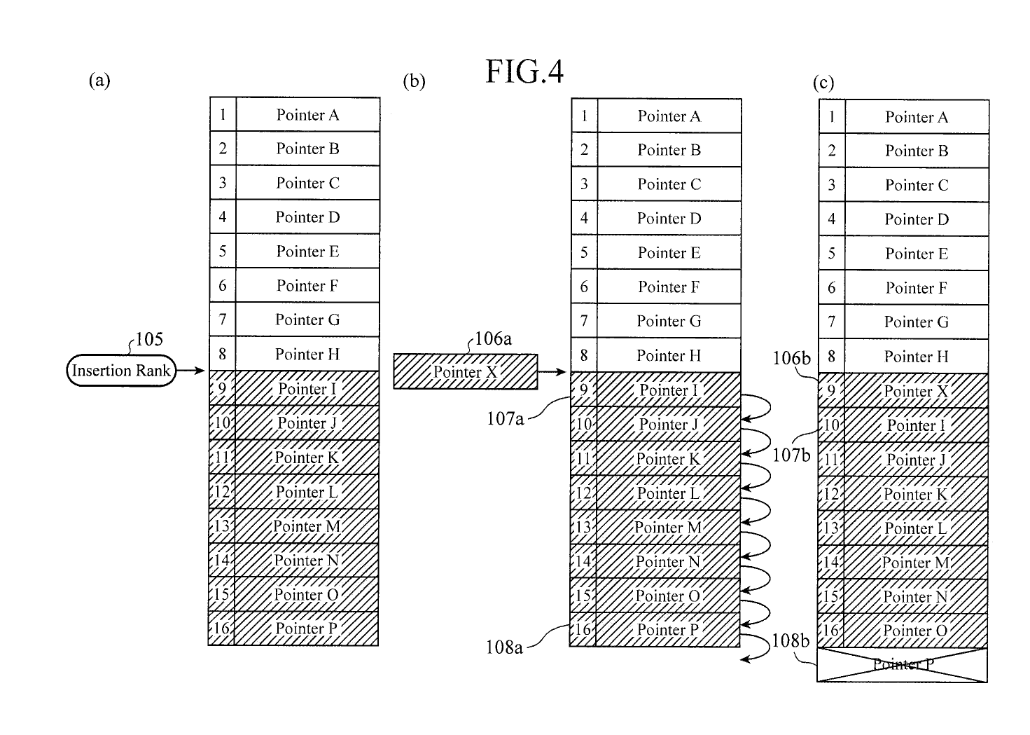

FIG. 4 is a figure for explaining the processes of steps ST2→ST3→ST4 in the flow chart of FIG. 3. An insertion rank 105 can be set to the management table 25 ((a) in the figure). When a drawing command for drawing vector graphics data pointed to by a pointer X 106a which does not exist in the management data is issued in a state in which the management table 25 are filled with only valid pointer data ((b) in the figure), the table management unit sets the rank of the pointer X 106a to the insertion rank 105, so that the rank of the pointer is the one 106b ((c) in the figure). Each of the ranks of other pointers 1107a to P 108a which are lower than the insertion rank 105 is decreased by one rank. The table management unit then deletes the pointer P 108b whose rank has become lower than the ranks manageable in the management table 25 from the management table 25 ((c) in the figure).

Although it is most desirable that the above-mentioned insertion rank 105 is set to be close to a branch point where the drawing device decides whether or not the vector graphics data pointed to by the pointer is cached to the cache unit 23, as shown in FIG. 4, the insertion rank is not limited to this point, but can be set arbitrarily.

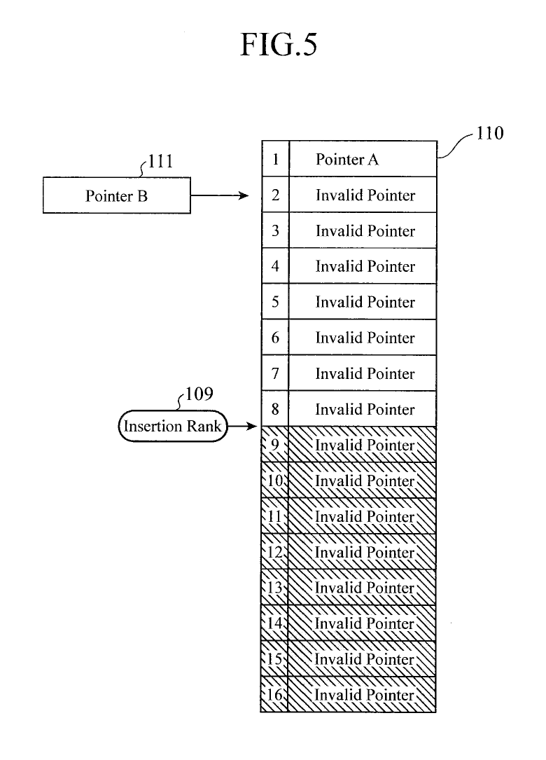

FIG. 5 is a figure for explaining the processes of steps ST2→ST3→ST5→ST6 in the flowchart of FIG. 3. When a drawing command for drawing vector graphics data pointed to by a pointer B 111 is issued in a case in which the rank of a pointer A 110 already stored in the management table is the first one, and all of the other pointer data are invalid, the table management unit sets the rank of the pointer B 111 to the second one. More specifically, the table management unit, in step ST6, sets the rank of the pointer B 111 to the rank of the first-ranked invalid pointer. After that, every time when receiving a drawing command for drawing vector graphics data pointed to by a pointer, the table management unit repeats the above-mentioned operation to set the rank of the pointer to the third, fourth, or . . . one in order until the rank reaches the insertion rank 109.

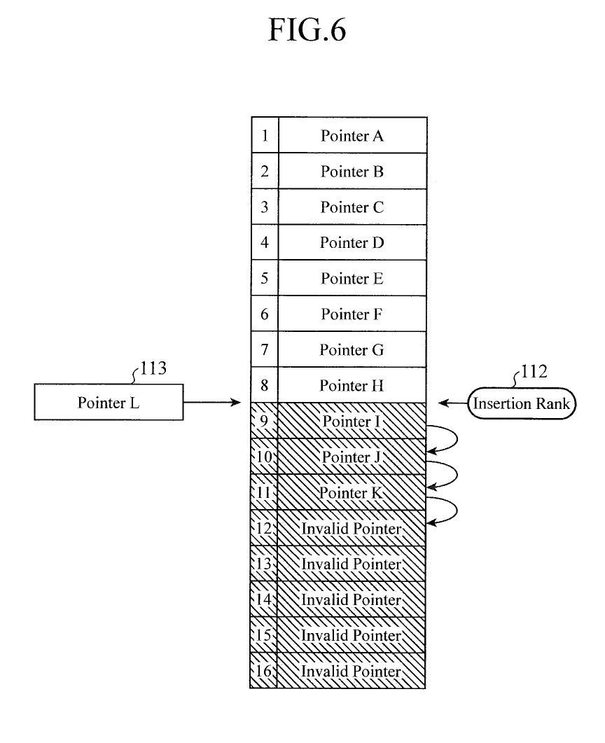

FIG. 6 is a figure for explaining the processes of steps ST2→ST3→ST5→ST4 in the flow chart of FIG. 3. When a drawing command for drawing vector graphics data pointed to by a pointer L 113 is issued in a case in which invalid pointer data is included at a lower rank than the insertion rank 112 in the management table, the table management unit sets the rank of the vector graphics data L 113 to the insertion rank 112. The table management unit decreases the rank of each of the pointer data located lower than the insertion rank 112 by one rank. This operation is the same as that performed in a case in which the pointer data pointing to the target to be drawn does not exist in the management table 25 (when No in step ST2), and no invalid pointer is included in the management table 25 (when No in step ST3).

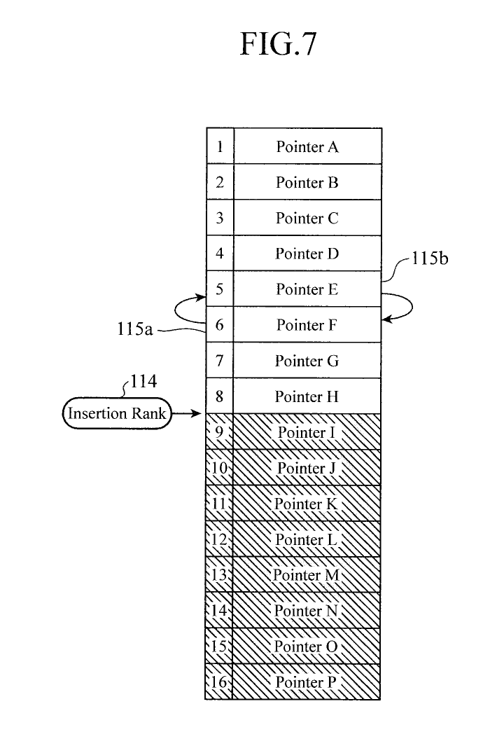

FIG. 7 is a figure for explaining the processes of steps ST2→ST7→ST8 in the flow chart of FIG. 3. When a drawing command for drawing vector graphics data pointed to by a pointer F 115a whose rank is higher than the insertion rank 114 is issued, the table management unit interchanges the pointer F and a pointer E 115b whose rank is one rank higher than the pointer F.

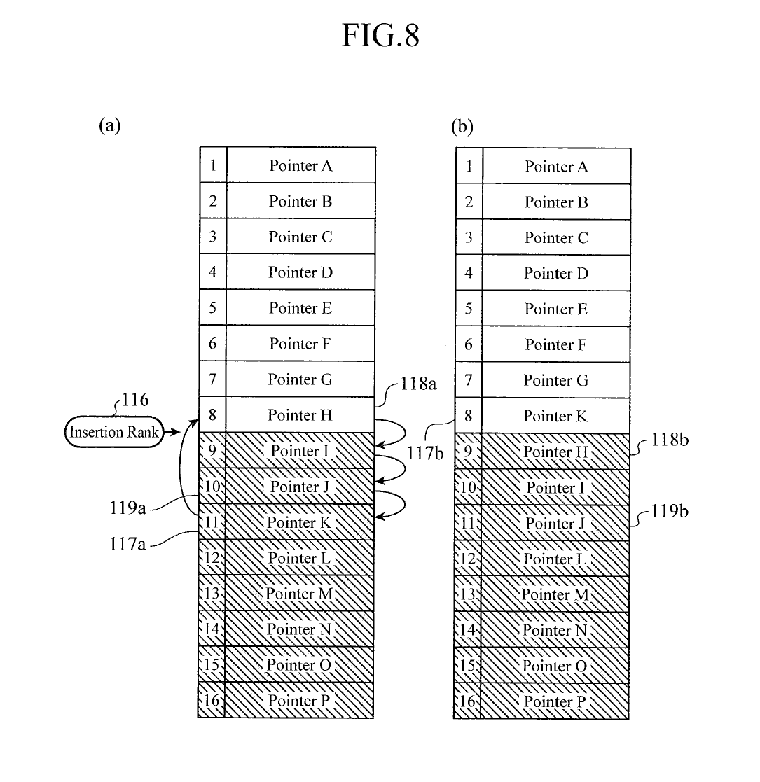

FIG. 8 is a figure for explaining the processes of steps ST2→ST7→ST9 in the flow chart of FIG. 3. When a drawing command for drawing vector graphics data pointed to by a pointer K 117a whose rank is lower than the insertion rank 116 is issued, the table management unit sets the rank of the pointer K 117a to a rank one rank higher than the insertion rank 116, and decreases each of the ranks of pointers including from a pointer H 118a previously located one rank higher than the insertion rank 116 to a pointer J 119a whose rank was one rank higher than the vector graphics data K 117a by one rank ((a) in the figure). Through this operation, the rank of the pointer K 117a is set to the rank 117b which is one rank higher than the insertion point, and each of the ranks of the pointers H 118b to J 119b is decreased by one rank.

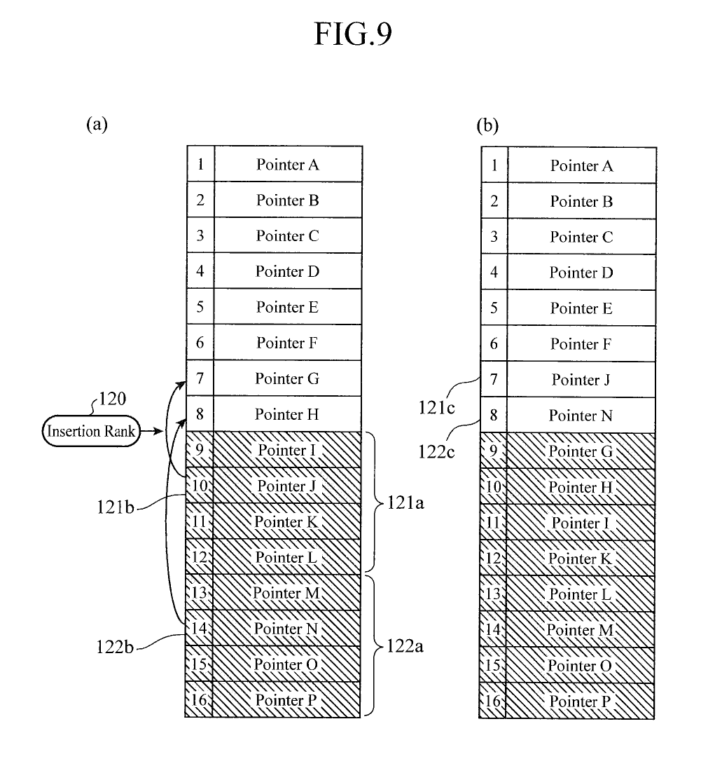

Although it is most desirable that when a drawing command for drawing vector graphics data pointed to by a data pointer whose rank is lower than the insertion point is issued for the above-mentioned management table 25, the rank of the above-mentioned data pointer in the management table 25 is set to a rank which is one rank higher than the insertion point, as shown in FIG. 8, the rank of the above-mentioned data pointer in the management table can be set in such a way as shown in, for example, FIG. 9, or can be set in another way.

In the example shown in FIG. 9, four ranks located lower than the insertion rank 120 are designated by 121a, and four ranks located further lower than the ranks 121a are designated by 122a. When a drawing command for drawing vector graphics data pointed to by pointer data 121b located at one of the ranks 121a is issued, the table management unit sets the rank of the pointer data to the rank which is two ranks higher than the insertion point ((a) in the figure). As a result, the rank of the pointer data is set to the rank designated by 121c ((b) in the figure). When a drawing command for drawing vector graphics data pointed to by pointer data 122b located at one of the ranks 122a is then issued, the table management unit sets the rank of the pointer data to the rank which is one rank higher than the insertion point ((a) in the figure). As a result, the rank of the pointer data is set to the rank designated by 122c ((b) in the figure). As mentioned above, the table management unit determines the rank to which the original rank is to be changed on the basis of the original rank with respect to the insertion point.

The configuration shown in FIG. 9 provides an advantage of making it easy for vector graphics data which is drawn locally and frequently to be stored in the cache unit 23. For example, a Japanese document will be considered. In a Japanese document, a portion in which a proper noun is used locally and frequently exists in many cases. In many cases, a proper noun is used about once in a sentence, and one sentence has about 40 to 50 characters in length. In a case of applying the management table 25 in accordance with the present invention to such a Japanese document, when the number of objects which are managed in the management table 25 is set to about 60 and an insertion rank is placed at a point close to a boundary point between the ranks where the drawing device stores the corresponding data in the cache unit 23 and the ranks where the drawing device does not store the corresponding data in the cache unit, as shown in FIG. 4, the characters used in a proper noun are cached in the cache unit when the proper noun appears the second time around, as shown in FIG. 8 or 9. On the other hand, characters used widely in a document have a higher rank and therefore an interchange of the rank of the characters with that of other characters hardly occurs. Because even while a proper noun is used locally in a region, those characters are expected to still have a low rank among the characters which are already cached to the cache unit, these characters are removed from the cache unit 23 when the target region for drawing is changed from the region in which the proper noun is used locally to another region.

In accordance with the LRU method as shown in patent reference 2, the cache hit ratio of a cache for data used widely is improved, while in accordance with the FIFO method as shown in patent reference 3, the cache hit ratio of a cache for data used locally is improved. The method in accordance with the present invention has the characteristics of the above-mentioned two methods, and maintains the cache hit ratios high for both data used widely and data used locally.

In the case of sorting data according to the frequency with which each of the data is called, as shown in patent references 4 and 5, local vector graphics data are hard to cache. Further, because it is necessary to sort data by using any of the methods, the scale of an actual implementation of each of the methods is large than that in accordance with the present invention.

As previously explained, because in accordance with Embodiment 1, there is provided a drawing device that generates image data to be displayed on a display device by using vector graphics data stored in an external storage unit, the drawing device including: a drawing unit responsive to a drawing command which includes a pointer pointing to vector graphics data stored in the external storage unit and which is outputted from an arithmetic device, for generating bit map data from the vector graphics data pointed to by the pointer; a cache unit for caching vector graphics data stored in the external storage unit; and a vector graphics data management unit having a management table for holding the pointer and a priority rank of a cache to the cache unit, for managing cached data in the cache unit on the basis of the management table and for carrying out transfer control of vector graphics data used by the drawing unit, in which the cache unit caches vector graphics data pointed to by a pointer whose priority rank held by the management table is high, and the vector graphics data management unit also manages a pointer whose priority rank is lower than that of the pointer pointing to the vector graphics data cached by the cache unit in the management table, the drawing device can prevent the circuit scale thereof from being enlarged and improve the drawing speed.

Further, because in the drawing device according to Embodiment 1, when receiving a drawing command, the vector graphics data management unit searches through the management table to determine whether a pointer included in the drawing command exits in the management table, and, when determining that the pointer exists in the management table, compares the rank of the pointer with a predetermined insertion rank and, when the insertion rank is lower than the rank of the pointer, increases the rank of the pointer by one rank, the drawing device can improve the cache hit ratio.

In addition, because in the drawing device according to Embodiment 1, when receiving a drawing command, the vector graphics data management unit searches through the management table to determine whether a pointer included in the drawing command exits in the management table, and, when determining that the pointer exists in the management table, compares the rank of the pointer with a predetermined insertion rank and, when the insertion rank is higher than the rank of the pointer, sets the rank of the pointer to a rank higher than the insertion rank, the drawing device can improve the cache hit ratio.

Further, because in the drawing device according to Embodiment 1, when receiving a drawing command, the vector graphics data management unit searches through the management table to determine whether a pointer included in the drawing command exits in the management table, and, when determining that the pointer does not exist in the management table and no invalid pointer is included in the management table, sets the pointer to a predetermined insertion rank, the drawing device makes it easy for vector graphics data drawn locally and frequently to be stored in the cache unit.

In addition, because in the drawing device according to Embodiment 1, when receiving a drawing command, the vector graphics data management unit searches through the management table to determine whether a pointer included in the drawing command exits in the management table, and, when determining that the pointer does not exist in the management table and an invalid pointer is included in the management table, compares the rank of the first-ranked invalid pointer with a predetermined insertion rank and, when the insertion rank is lower than the rank of the first-ranked invalid pointer, sets the pointer to the rank of the first-ranked invalid pointer, otherwise, sets the pointer to the insertion rank, the drawing device can make the management of the caches appropriate when an invalid pointer is included in the management table.

Further, because in the drawing device according to Embodiment 1, when the pointer included in the drawing command does not exist in the management table, the vector graphics data management unit sets an insertion rank where a pointer is set to the management table to be close to a branch point where the vector graphics data management unit decides whether or not vector graphics data pointed to by the pointer is cached to the cache unit, the drawing device can optimize the management of the caches.

### Embodiment 2

Although the drawing device that is constructed in such a way as to automatically all of the management of caches is shown in above-mentioned Embodiment 1, an embodiment in which when a user manages caches, a drawing device enables the user to make a setting for inhibiting an interchange of caches will be shown hereafter. Because the drawing device in accordance with Embodiment 2 has the same structure as that in accordance with FIG. 1 in terms of drawings, the explanation of the structure will be omitted in Embodiment 2.

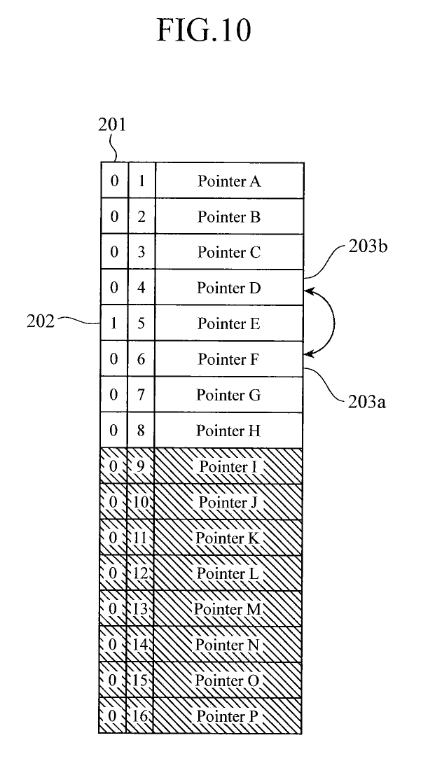

FIG. 10 shows the configuration of a management table 25 in accordance with Embodiment 2. Rank interchange inhibit flags 201 are disposed in the management table 25, as shown in FIG. 10. For example, in a case in which a rank interchange inhibit flag is set to a pointer E 202, when a drawing command for drawing vector graphics data pointed to by a pointer F 203a whose rank is one rank lower than that of the pointer E is issued, a vector graphics data management unit skips the pointer E 202 and interchanges the rank of the pointer F 203a with that of a pointer D 203b. As a result, as long as the rank interchange inhibit flag is set to the pointer E 202, the rank of the pointer E 202 is fixed and hence the vector graphics data pointed to by the pointer E can continue to be stored in a cache unit 23.

For example, in a case in which an external storage unit 30 having very slow data fetch performance exists and vector graphics data is stored in the external storage unit 30, the vector graphics data management unit can secure any data to the cache unit 23 by simply fixing the rank of the data in the management table 25, and therefore the drawing device can accomplish the acquisition of the above-mentioned data by issuing a request to acquire the data to the external storage device 30 only once.

As previously explained, because in the drawing device according to Embodiment 2, the vector graphics data management unit sets the priority rank of either one of pointers in the management table to a fixed rank, the vector graphics data management unit can continue to hold specific vector graphics data in the cache unit.

### Embodiment 3

Although only an inhibition against an interchange of the ranks of pointers in the cache is imposed on specific data in above-mentioned Embodiment 2, the user is enabled to generate a management table 25 in advance, and set this management table to be an initial management table 25 when, for example, characters used widely, such as alphabetic characters, can be predicted in advance. With the above-mentioned structure, the drawing device can improve the cache hit ratio in its initial state.

While the invention has been described in its preferred embodiments, it is to be understood that an arbitrary combination of two or more of the embodiments can be made, various changes can be made in an arbitrary component in accordance with any one of the embodiments, and an arbitrary component in accordance with any one of the embodiments can be omitted within the scope of the invention.

### INDUSTRIAL APPLICABILITY

As mentioned above, the graphics drawing device in accordance with the present invention caches vector graphics data and is aimed at improving the drawing speed, and is suitable for displaying vector graphics data in applications to built-in displays which use vector graphics data, such as a display used in railroad applications, a vehicle-mounted display, a display for industrial use, an AV display, an operation panel of a household electrical appliance, an operation panel of a portable terminal, and a printer.

### EXPLANATIONS OF REFERENCE NUMERALS

10 arithmetic device, 20 drawing device, 21 host bus interface unit, 22 drawing unit, 23 cache unit, 24 vector graphics data management unit, 25 management table, 26 table management unit, 27 memory interface unit, 30 external storage unit, 40 display device.

1. A drawing device that generates image data to be displayed on a display device by using vector graphics data stored in an external storage unit, said drawing device comprising:
a drawing unit responsive to a drawing command which includes a pointer pointing to vector graphics data stored in said external storage unit and which is outputted from an arithmetic device, for generating bit map data from the vector graphics data pointed to by said pointer;
a cache unit for caching vector graphics data stored in said external storage unit; and
a vector graphics data management unit having a management table for holding said pointer and a priority rank of a cache to said cache unit, for managing cached data in said cache unit on a basis of said management table and for carrying out transfer control of vector graphics data used by said drawing unit, wherein
said cache unit caches vector graphics data pointed to by a pointer whose priority rank held by said management table is high, and said vector graphics data management unit also manages a pointer whose priority rank is lower than that of the pointer pointing to said vector graphics data cached by said cache unit in said management table.

2. The drawing device according to claim 1, wherein when receiving a drawing command, the vector graphics data management unit searches through the management table to determine whether a pointer included in said drawing command exits in said management table, and, when determining that the pointer exists in said management table, compares a rank of said pointer with a predetermined insertion rank and, when said insertion rank is lower than the rank of said pointer, increases the rank of said pointer by one rank.

3. The drawing device according to claim 1, wherein when receiving a drawing command, the vector graphics data management unit searches through the management table to determine whether a pointer included in said drawing command exits in said management table, and, when determining that the pointer exists in said management table, compares a rank of said pointer with a predetermined insertion rank and, when said insertion rank is higher than the rank of said pointer, sets the rank of said pointer to a rank higher than said insertion rank.

4. The drawing device according to claim 1, wherein when receiving a drawing command, the vector graphics data management unit searches through the management table to determine whether a pointer included in said drawing command exits in said management table, and, when determining that the pointer does not exist in said management table and no invalid pointer is included in said management table, sets said pointer to a predetermined insertion rank.

5. The drawing device according to claim 1, wherein when receiving a drawing command, the vector graphics data management unit searches through the management table to determine whether a pointer included in said drawing command exits in said management table, and, when determining that the pointer does not exist in said management table and an invalid pointer is included in said management table, compares a rank of a first-ranked invalid pointer with a predetermined insertion rank and, when said insertion rank is lower than the rank of the first-ranked invalid pointer, sets said pointer to the rank of the first-ranked invalid pointer, otherwise, sets said pointer to said insertion rank.

6. The drawing device according to claim 1, wherein when the pointer included in the drawing command does not exist in the management table, the vector graphics data management unit sets an insertion rank where a pointer is set to said management table to be close to a branch point where the vector graphics data management unit decides whether or not vector graphics data pointed to by said pointer is cached to the cache unit.

7. The drawing device according to claim 1, wherein the vector graphics data management unit sets a priority rank of either one of pointers in the management table to a fixed rank.

8. The drawing device according to claim 1, wherein the vector graphics data management unit starts the management in a state in which a pointer set for each priority rank is predetermined in the management table as an initial state.
